(19) United States
(12) Patent Application Publication
(10) Pub. No.: US 2011/0177788 A1
(43) Pub. Date: Jul. 21, 2011

(54) WIRELESS COMMUNICATION APPARATUS AND WIRELESS COMMUNICATION METHOD

(75) Inventor: Taku Nakayama, Yokohama-shi (JP)

(73) Assignee: KYOCERA CORPORATION, Kyoto (JP)

(21) Appl. No.: 13/120,868

(22) PCT Filed: Sep. 25, 2009
(86) PCT No.: PCT/JP2009/066696

§ 371 Date: Mar. 24, 2011

(30) Foreign Application Priority Data
Sep. 26, 2008 (JP) 2008-248824

(51) Int. Cl. H04B 7/00

(52) U.S. Cl. 455/69

(57) ABSTRACT

Provided is a wireless communication apparatus, which enhances communication characteristics of feedback MIMO by switching transmission weight selection processing based on a channel state to select a suitable transmission weight with a small calculation load. A wireless communication apparatus has a plurality of antennas, and includes a reception unit for receiving signals of channels included in a predetermined frequency band from another wireless communication apparatus and for obtaining channel state information of the channels, a determination unit for determining a variation in the channel state information, a channel state information calculation unit for calculating an average value of all of the channel state information included in the predetermined frequency band as representative channel state information of the predetermined frequency band overall if there is no variation in the channel state information, a transmission weight selection unit for selecting a transmission weight based on the representative channel state information calculated, and a transmission unit for transmitting identification information of the transmission weight to the another wireless communication apparatus.

### CROSS REFERENCE TO RELATED APPLICATION

This application claims priority to and the benefit of Japanese Patent Application No. 2008-248824 (filed on Sep. 26, 2008), the entire contents of which are incorporated herein by reference.

### TECHNICAL FIELD

The present invention relates to wireless communication apparatuses and wireless communication methods.

### BACKGROUND ART

In recent years, wireless communication systems have used a plurality of antennas for transmission and reception of signals in order to increase a communication capacity and to improve communication quality. Such transmission and reception scheme using a plurality of antennas is called MIMO (Multi-Input Multi-Output). In particular, a scheme that a reception terminal feedbacks information on CSI (Channel State Information: propagation path information) to a transmission terminal is called Closed-Loop MIMO or feedback MIMO, which further improves communication characteristics of MEMO.

The reception terminal can measure CSIₖ with regard to a k-th subcarrier (channel) as shown. in Formula 1 based on a relationship between a specific reference signal (xᵢ) transmitted by the transmission terminal at predetermined intervals and a reception signal (y_{j,i}) at the reception terminal. Here, k represents an index of subcarrier and, in OFDM system adopted by 3.9 generation mobile communication system (hereinafter, referred to as “3.9G”), is a value uniquely determined by a two dimensional coordinate of a frequency and a time, In Formula 1, TxAnt and RxAnt respectively represents the number of antennas of the transmission terminal and the number of antennas of the reception. terminal, whereas CSIₖ represents complex matrix having a dimension of RxAnt×TxAnt. In many cases, the reference signals are inserted in different subcarriers for each transmission antenna in fact, such that the reception terminal can separate the reception signals. However, for the sake of simplicity, it is assumed here that the reception signals and the reference signals of all subcarriers are obtained separately by each antenna.

$${CSI}_{k} = [ \begin{matrix}\frac{{y}_{0 , 0}}{{x}_{0}} & \frac{{y}_{0 , 1}}{{x}_{1}} & ⋯ & \frac{{y}_{0 , TxAnt - 1}}{{x}_{TxAnt - 1}} \\ \frac{{y}_{1 , 0}}{{x}_{0}} & \frac{{y}_{1 , 1}}{{x}_{1}} & & \frac{{y}_{1 , TxAnt - 1}}{{x}_{TxAnt - 1}} \\ ⋮ & & ⋱ & ⋮ \\ \frac{{y}_{RxAnt - 1 , 0}}{{x}_{0}} & \frac{{y}_{RxAnt - 1 , 1}}{{x}_{1}} & ⋯ & \frac{{y}_{RxAnt - 1 , TxAnt - 1}}{{x}_{TxAnt - 1}}\end{matrix} ] \qquad [ Formula 1 ]$$

As for the feedback MIMO, the communication characteristics of MIMO are more improved, as the information on the CSI provided as feedback from the reception terminal to the transmission terminal is more detailed. However, an amount of communication data is more increased as the information on the CSI provided as feedback by the reception terminal is more detailed, resulting in tightening the wireless communication capacity of the system. In order to address such a problem, it has been performed that the transmission terminal and the reception terminal commonly have information on a transmission weight and the reception terminal feedbacks only index information (identification information) of the transmission weight corresponding to the CSI to the transmission terminal (that is, the reception terminal notifies the transmission terminal of an index number of transmission weight to be used only), which significantly reduces feedback information. In addition, applying a single transmission weight to a plurality of subcarriers collectively can reduce an index itself of the transmission weight to be fed back, enabling further reduction in the feedback information.

For example, in UMB (Ultra Mobile Broadband, see Non-Patent Document 1, for example) or E-UTRA (LTE) (Evolved. UMTS Terrestrial Radio Access, Long Term Evolution, see Non-Patent Document 2, for example), which is a kind of the 3.9G, the information on the transmission weight stated above is shared as PM (Precoding Matrix) by the transmission terminal and the reception terminal. A plurality of PMs is defined correspondingly to the number of a plurality of antennas and the like. The reception terminal selects an optimum PM based on the CSI and feedbacks a PMI (Precoding Matrix Index), which is an identification number of the PM, to the transmission terminal. When receiving the PMI from the reception terminal, the transmission terminal controls the transmission weights of the plurality of antennas by using the PM identified by the PMI.

For example, as shown in FIG. 4, E-UTRA (LTE) divides a frequency band used for a communication into four subbands, divides each subband into twelve resource blocks (RB) and further divides each resource block into twelve subcarriers. In B-UTRA (LTE), in order to select a PM commonly applied to a plurality of subcarriers, the reception terminal selects the transmission. weight (PM) of the subband as a unit and feedbacks a PMI corresponding to the PM of the subband to the transmission terminal. It is to be noted that, in E-UTRA. (LTE), the number of resource blocks per subband is not limited to 12 as described above but may be variable, For example, if the frequency band used for the communication is divided into 9 subbands, each subband is divided into 2 to 6 resource blocks, and each of the resource blocks is divided into 12 subcarriers. In addition, for example, UMB divides the frequency band used for the communication into 8 subbands, divides each of the subbands into 8 tiles and further divides each of the tiles into 16 subcarriers. In UMB, similarly to E-UTRA (LIE), the PM is selected for a subband as a unit.

FIG. 9 is a flowchart illustrating a PM selection for a subband as a unit by B-UTRA (LTE). With reference to FIG. 9, a conventional method to select the PM for the subband as the unit by E-UTRA. (LTE) is described in detail.

The reception terminal first obtains the CSIs of all subcarriers included in a subband range (step S101). FIG. 5 is a diagram illustrating an example of frequency selectivity according to different channels. As shown in FIG. 5 by way of example, the CSI of each subcarrier varies under circumstances and there may be a number of cases such as, for example, in which the CSI of each subcarrier largely varies or each subcarrier varies relatively less as referred to as flat fading, According to the conventional art, the reception terminal performs the same transmission weight selection processing (step S102-S106) for all cases having such as a large variation in the CSI of each subcarrier or the flat fading.

The reception. terminal has a plurality of transmission weight candidates W_{Tx,i} (i represents the PMI, the identification number of the transmission weight and satisfies i<the number of transmission weights). In order to select an optimum transmission weight for the subband as the unit from the plurality of transmission weight candidates W_{Tx,i}, the reception terminal calculates a total of SINK (Signal-to-Interference and Noise power Ratio) of all subcarriers in the subband with regard to each of the transmission weight candidates W_{Tx,i} (step S103-S105).

At step S 104, the reception terminal first multiplies CSIₖ of a subcarrier k (0≦k<N_{CSI}, where N_{CSI} represents the number of carriers included in the subband) in the subband and the transmission weight candidate W_{Tx,i} as shown in Formula 2,

CSIₖ·W_{Tx,i[Formula} 2]

At step S104, the reception terminal next performs processing on the basis of a MIMO reception scheme such as, for example, V-BLAST (Vertical Bell Laboratories Layered Space Time), QRM-MLD (Maximum Likelihood Detection With Cir-Decomposition and M-algorithm) and MMSE (Minimum Mean Square Error) on a result of the Formula 2, in order to create an expected reception weight W_{RX} of the subcarrier k. Formula 3 expresses the expected reception weight W_{RX} of the subcarrier k in an MMSE reception. In the Formula 3, (A)⁺represents a pseudo-inverse matrix of a matrix A.

$${W}_{Rx} = {[ {CSI}_{k} \cdot {W}_{Tx , j} + [ \begin{matrix}\frac{1}{SNR} & 0 & ⋯ & 0 \\ 0 & \frac{1}{SNR} & ⋱ & ⋮ \\ ⋮ & ⋱ & ⋱ & 0 \\ 0 & ⋯ & 0 & \frac{1}{SNR}\end{matrix} ] ]}^{+} \qquad [ Formula 3 ]$$

At step S104, the reception terminal lastly multiplies the transmission weight W_{Tx,i}, the CSI_{K} and the reception weight W_{RX} to calculate the SINR assuming a channel response between transmission and reception of a corresponding subcarrier k.

The reception terminal performs the above calculation for all of the subcarriers in the subband range with regard to a transmission weight candidate and adds the SINR of each subcarrier (step S105).

Upon finishing the calculation of sum of the SINR with regard to all of the transmission weight candidates W_{Tx,i} (Step S103-S105) (YES of step S102), the reception terminal selects a transmission weight (PM) with a maximum total value of the SINR from the transmission weight candidates W_{Tx,i} (step S 106) and feedbacks the PMI corresponding to the PM to the transmission terminal. Formula 4 expresses the above process.

$${max}_{i ∈ PMI} ( {\sum }_{k = 0}^{{N}_{CSI} - 1} SINR ( {W}_{Rx} \cdot {CSI}_{k} \cdot {W}_{Tx , i} ) ) \qquad [ Formula 4 ]$$

### PRIOR ART DOCUMENTS

### Non-Patent Documents

Non-Patent Document 1: “Physical Layer for Ultra. Mobile Broadband (OMB), Air Interface Specification (C.S0084-001-0 v1.0)”, 3GPP2, April 2007

Non-Patent Document 2: “Multiplexing and channel coding (3GPP TS 36.212)”, 3GPP, May 2008

### SUMMARY OP INVENTION

### Technical Problem

As described above, according to the conventional method, the reception terminal can select a transmission weight according to a channel variation in a range to apply a common transmission weight (PM) (hereinafter, referred to as “transmission weight applicable range”), such as a subband as the unit and the like. However, there is a problem that, since the conventional method calculates the SINR of all of the transmission weight candidates and all of the subcarriers by a matrix operation of a dimension of the number of reception antennas×the number of transmission antennas in the transmission weight selection processing, it greatly expands a calculation amount necessary for selection of the transmission weight In E-UTRA. (LIE), for example, the N_{CSI} is 144 (12×12), for example, and, in consideration of 14 symbols in a direction of a time, it is necessary to execute the above matrix operation about 2000 times to select the transmission weight of the subband as the unit. Moreover, there is another problem that, since advanced MIMO requires more reception antennas and transmission antennas, the calculation amount is dramatically increased.

Accordingly, an object of the present invention in consideration of the above problems is to provide a wireless communication apparatus and a wireless communication method which select a suitable transmission weight with a small calculation load by switching processing to select the transmission weight based on a channel condition, and therefore, enhance communication characteristics of the feedback MIMO.

### Solution to Problem

In order to solve the above problems, a wireless communication apparatus having a plurality of antennas according to the present invention includes:

a reception unit for receiving signals of channels included in a predetermined frequency band from another wireless communication apparatus and for obtaining channel state information of the channels;

a determination unit for determining a variation in the channel state information;

a channel state information calculation unit for calculating an average value of all of the channel state information included in the predetermined frequency band as representative channel state information of the predetermined frequency band overall, if there is no variation in the channel state information;

a transmission weight selection unit for selecting a transmission weight based on the representative channel state information calculated; and

a transmission unit for transmitting identification information of the transmission weight to the another wireless communication apparatus.

It is preferred that the determination unit determines that there is no variation in the channel state if all of the channel state info/motion is equal to or over a threshold based on the average value of all of the channel state information.

It is preferred that transmission weight selection unit stores a corresponding relation between channel state information and the transmission weight and selects the transmission weight stored corresponding to the representative channel state information.

In order to solve the above problems, a wireless communication method of a wireless communication apparatus having a plurality of antennas according to the present invention includes the steps of:

receiving signals of channels included in a predetermined frequency band from another wireless communication apparatus and obtaining channel state information of the channels;

determining a variation in the channel state information;

calculating an average value of all of the channel state information included in the predetermined frequency band as representative channel state information of the predetermined frequency band overall if there is no variation in the channel state information;

a step for selecting a transmission weight based on the representative channel state information calculated; and

a step for transmitting identification information of the transmission weight to the another wireless communication apparatus.

It is preferred, at the step of determination, to determine that there is no variation in the channel state if all of the channel state information is equal to or over a threshold based on the average value of the channel state information.

It is preferred, at the step of selecting the transmission weight, to select the transmission weight corresponding to the representative channel state information based on a corresponding relation between the channel state information and the transmission weight stored in advance.

### EFFECT OF THE INVENTION

According to the present invention, the channel state between a transmission and a reception is determined based on CSI information and transmission weight selection processing is switched according to a variation in the channel. Thereby, it is possible to improve communication characteristics of feedback MIMO by selecting a suitable transmission weight with a small calculation load if there is no variation in the channel.

### BRIEF DESCRIPTION OP DRAWINGS

FIG. 1 is a diagram illustrating a schematic constitution of a communication network which a communication terminal according to one embodiment of the present invention can use;

FIG. 2 is a diagram illustrating a configuration of the communication terminal according to the embodiment of the present invention;

FIG. 3 is a flowchart of operations by the communication terminal according to an embodiment of the present invention;

FIG. 4 is a diagram illustrating exemplary units of dividing a frequency band;

FIG. 5 is a diagram illustrating an example of frequency selectivity according to different channels;

FIG. 6 is a diagram illustrating throughput characteristics at MIMO communication;

FIG. 7 is a diagram illustrating the throughput characteristics at the MIMO communication;

FIG. 8 is a diagram illustrating calculation amounts necessary for a selection of a transmission weight; and

FIG. 9 is a flowchart of conventional operations by a communication terminal.

### DESCRIPTION OF EMBODIMENT

An embodiment of the present invention will be described with reference to the accompanying drawings.

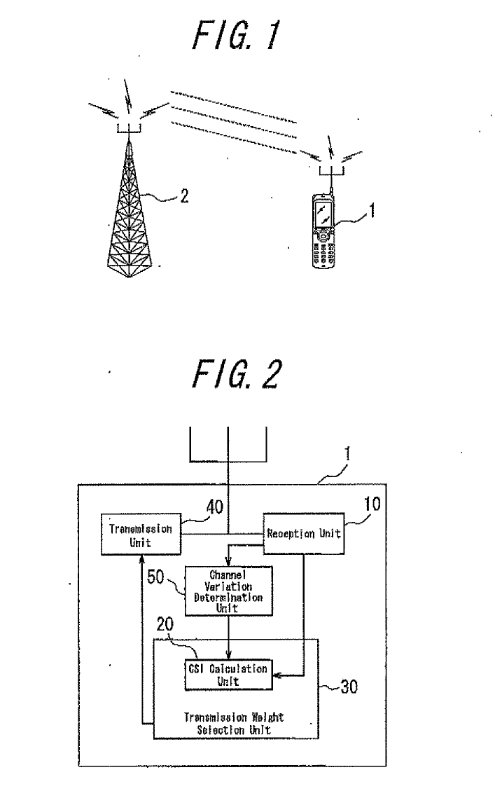

FIG. 1 is a diagram illustrating a schematic constitution of a communication network which a communication terminal 1 according to one embodiment of the present invention can use. In FIG. 1, the communication terminal 1 performs communications with a base station 2 by MIMO using a plurality of antennas. The communication terminal 1 obtains CSI of each subcarrier from a reference signal transmitted by the base station 2, After performing a predetermined processing on the CSI, the communication terminal 1 selects a transmission weight (PM) which the base station 2 should use, and feedbacks a transmission weight index corresponding to the transmission weight to the base station 2, The base station 2 selects a transmission weight corresponding to the transmission weight index and controls feedback MIMO.

FIG. 2 is a diagram illustrating a configuration of the communication terminal 1 according to the embodiment of the present invention. Here, the communication terminal 1 may be, for example, a mobile phone, a notebook computer or a PDA (Personal Digital Assistance) having a communication interface for MIMO. The communication terminal 1 has a reception unit 10 for receiving signals from the base station 2 and obtaining CSI of a subcarrier, a channel variation determination unit (determination unit) 50 for determining a channel variation by obtaining information on the CSI from the reception unit 10, a CSI calculation unit (channel state information calculation unit) 20 for performing a predetermined calculation related to the CSI by obtaining the information on the CSI from the reception unit 10 as well as a variation state of the channel from the channel variation determination unit 50, a transmission weight selection unit 30 for selecting a transmission weight index of the transmission weight to be fed back to the base station 2 based on a result of calculation by the CSI calculation rink 20, and a transmission unit 40 for transmitting the transmission weight index, selected by the transmission weight selection unit 30, together with communication data and the like to the base station 2.

The reception unit 10 and the transmission unit 40 may be implemented by interface devices corresponding to the feedback MIMO of such as, for example, E-UTRA (LTE), UMB and other suitable systems. The reception unit 10 and the transmission unit 40 may have normal functions, such as modulation/demodulation of signals necessary for transmission and reception of wireless signals, decode/encode of error correction, PS/SP conversion, channel estimation and the like, which are required for transmission and reception in wireless communications, The channel variation determination unit 50, the CSI calculation unit 20 and the transmission weight selection unit 30 may be any suitable processor such as a CPU (Central Processing Unit) and the like, and each function of the CSI calculation unit 20 and the transmission weight selection unit 30 may be implemented by a software executed on the processor or a special processor exclusive for processing of each function (for example, DSP (Digital Signal Processor)).

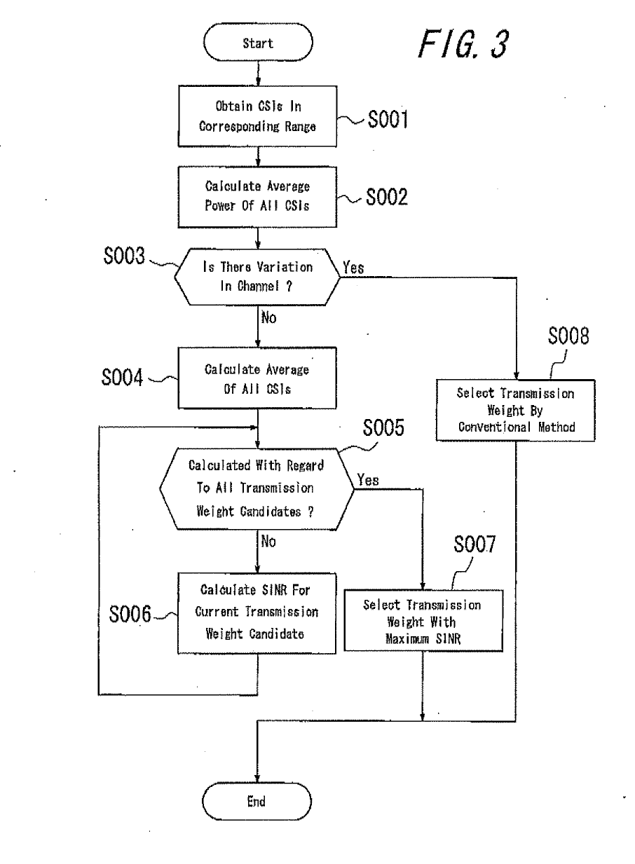

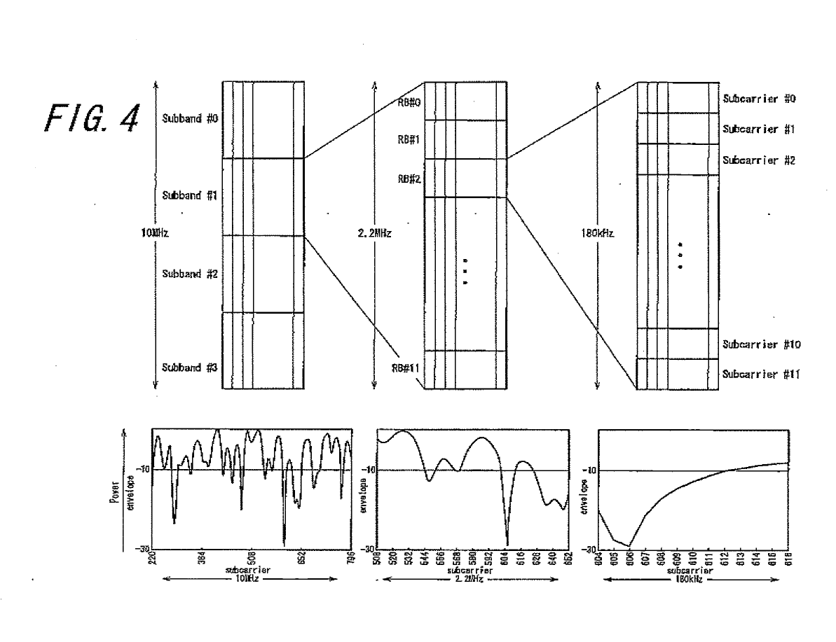

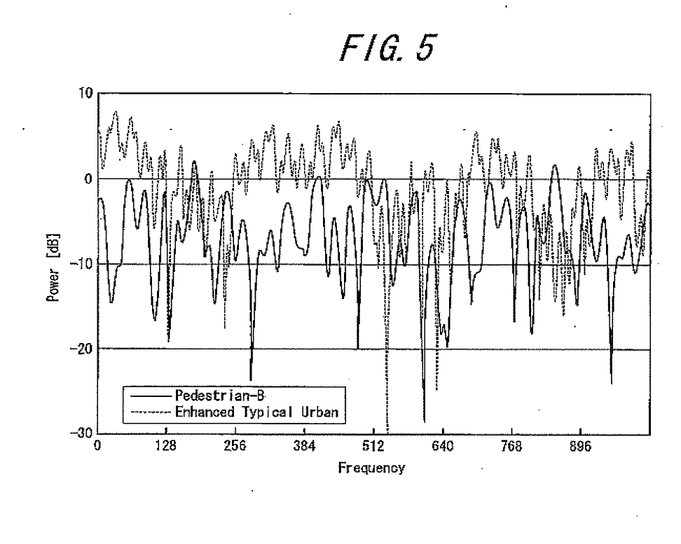

FIG. 3 is a flowchart illustrating operations by the communication terminal according to an embodiment of the present invention. The operation of each function block of the communication terminal 1 will be described in detail with reference to this flowchart.

When the communication terminal 1 receives a reference signal from the base station 2, the CSI calculation unit 20 of the communication terminal 1 obtains the CSIs of subcarriers in a transmission weight applicable range from the reception unit 10 (step S001). According to the present embodiment, 144 subcarriers (N_{CSI}=144) are included in the transmission weight applicable range, for example. It will be appreciated to those skilled in the art that the number of subcarriers included in the transmission weight applicable range is not limited to 144.

The channel variation determination unit 50 calculates average power of the CSI (Pow_{Ave},) included in the transmission weight applicable range by using Formula 5 (step S002).

$${Pow}_{Ave} = \frac{1}{{N}_{CSI}} {\sum }_{i = 0}^{{N}_{CSI} - 1} {\vert {CSI}_{i} \vert}^{2} = \frac{1}{{N}_{CSI}} {\sum }_{j = 0}^{{N}_{CSI} - 1} {[ \begin{matrix}{\vert \frac{{y}_{0 , 0}}{{x}_{0}} \vert}^{2} & {\vert \frac{{y}_{0 , 1}}{{x}_{1}} \vert}^{2} & ⋯ & {\vert \frac{{y}_{0 , TxAnt - 1}}{{x}_{TxAnt - 1}} \vert}^{2} \\ {\vert \frac{{y}_{1 , 0}}{{x}_{0}} \vert}^{2} & {\vert \frac{{y}_{1 , 1}}{{x}_{1}} \vert}^{2} & & {\vert \frac{{y}_{1 , TxAnt - 1}}{{x}_{TxAnt - 1}} \vert}^{2} \\ ⋮ & & ⋱ & ⋮ \\ {\vert \frac{{y}_{RxAnt - 1 , 0}}{{x}_{0}} \vert}^{2} & {\vert \frac{{y}_{RxAnt - 1 , 1}}{{x}_{1}} \vert}^{2} & ⋯ & {\vert \frac{{y}_{RxAnt - 1 , TxAnt - 1}}{{x}_{TxAnt - 1}} \vert}^{2}\end{matrix} ]}_{i} = \frac{1}{{N}_{CSI}} {\sum }_{i = 0}^{{N}_{CSI} - 1} {( {\sum }_{j = 0}^{TxAnt - 1} {\sum }_{k = 0}^{RxAnt - 1} {\vert \frac{{y}_{k , j}}{{x}_{j}} \vert}^{2} )}_{i} \qquad [ Formula 5 ]$$

The channel variation determination unit 50 determines whether there is a variation in the CSI included in the transmission weight applicable range by using a result of calculation of the average power (step S003). This determination is for determining whether there is a drop caused by a factor such as the frequency selectivity and the like. Such variation is determined based on whether the power of CSI of each subcarrier is lower than a determination standard (threshold) set on the basis of the average power of the CSIs of the transmission weight applicable range. The determination standard may be a value of the average power itself of the CSIs in the transmission weight applicable range or a value calculated by multiplication or division of the value of the average power by a predetermined coefficient (for example, ×0.8, ×1.2, ×½, ×⅓ and the like) or by addition or subtraction (for example, +1, −0.5 as offset) to/from the value of the average power. Setting the determination standard higher results in a higher probability to be determined that there is a variation, whereas setting the determination standard lower results in a lower probability to be determined that there is a variation. In addition, it is also possible to determine whether there is a variation based on the number of CSIs lower than the determination standard. In such a case, it is possible to determine that there is a variation if, for example, the number of CSIs lower than the determination standard exceeds a predetermined value.

The CSI calculation unit 20 calculates a representative CSI (representative channel state information) in the transmission weight applicable range overall, based on a result of determination by the channel variation determination unit 50. If there is no variation in the channel (No of step S003), it is assumed that, for example, the CSI of each subcarrier is in a flat fading state. Therefore, the CSI calculation unit 20, by using Formula 6, Calculates an average value of the CSIs (CSI_{Ave}) in the transmission weight applicable range and sets the average value as the representative CSI (Step S004). This is because, since the calculation of the average value can reduce an influence by a CSI estimation error due to noise included in the CR of each subcarrier under a circumstance similar to the fiat fading state, it is possible to select a suitable transmission weight by calculating SINR of the representative CSI and the transmission weight candidates without calculating the SINR of the transmission weight candidates for each CSI, individually.

$${CSI}_{Ave} = \frac{1}{{N}_{CSI}} {\sum }_{i = 0}^{{N}_{CSI} - 1} {CSI}_{j} = \frac{1}{{N}_{CSI}} ( {\sum }_{i = 0}^{{N}_{CSI} - 1} Re ( {CSI}_{i} ) + J {\sum }_{i = 0}^{{N}_{CSI} - 1} Im ( {CSI}_{i} ) ) \qquad [ Formula 6 ]$$

The transmission weight selection unit 30 selects a transmission weight based on the representative CM (CSI_{Ave}) provided from the CSI calculation unit 20 (step S005-S007), At steps 5005 and 5006, the transmission weight selection unit 30 calculates the Mk of all of the transmission weight candidates that the transmission weight selection unit 30 has and the representative CSI (CSI_{Ave}) by using Formula 2 and Formula 3, Upon finishing calculation of the SINR with regard to all of the transmission weight candidates (Yes of step S005), the transmission weight selection unit 30 selects the transmission weight with a maximum SINR as the transmission weight for the representative CSI (CSI_{Ave}) (step S007). Formula 7 expresses the above selection process by the transmission weight selection unit 30. A comparison of Formula 7 and Formula 4, which is a conventional method, shows that, since the transmission weight selection unit 30 selects the transmission weight based only on the representative CSI (CSI_{Ave}) provided from the CSI calculation unit 20, it is possible to reduce the number of matrix operations to I/N_{CSI} comparing to a case of individually calculating the SINR of the transmission weight candidates for each CSI. The transmission weight selection unit 30 feedbacks a transmission weight index corresponding to the transmission weight selected to the base station 2 via the transmission unit 40.

$${max}_{i ∈ PMI} ( SINR ( {W}_{Rx} \cdot {CSI}_{Ave} \cdot {W}_{Tx , i} ) ) \qquad [ Formula 7 ]$$

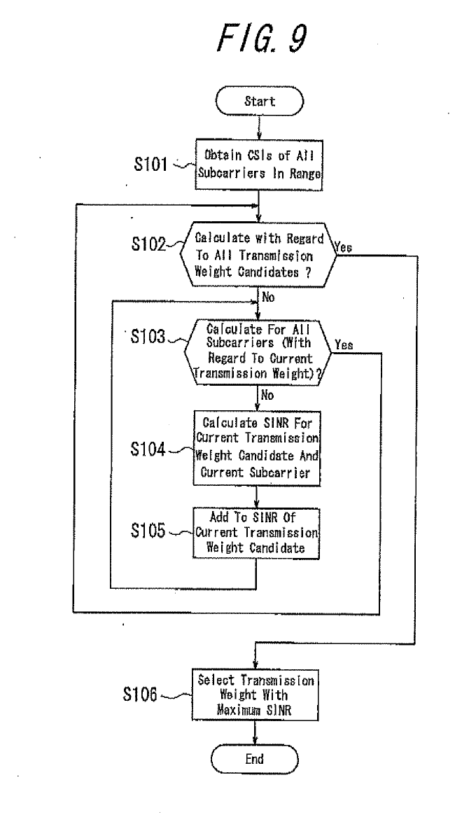

If there is a variation in the channel (Yes of step S003), the CSI calculation unit 20 selects a transmission weight by a conventional method as shown at steps S101-S106 in FIG. 9. That is, the CSI calculation unit 20 performs the matrix operation of the dimension of the number of reception antennas×the number of transmission antennas on all of predefined transmission weight (PM) candidates and the CSIs of all of the subcarriers included in the frequency band used for the communication.

In addition, the transmission weight selection unit 30 may store, in advance, a corresponding relation between the CSI and the transmission weight and select the transmission weight corresponding to the representative channel state information based on the corresponding relation.

The base station 2 can improve communication characteristics of the feedback MIMO by selecting a transmission weight by using the transmission weight index fed back from the communication terminal 1.

According to the present embodiment, since it is assumed that, if there is no drop of the CSI, the CSI of each subcarrier is in the flat fading state, it is possible to select a. suitable transmission weight with a small calculation amount (small power consumption) by selecting the transmission weight by using the average value of the CSIs (CSI_{Ave}) in the transmission weight applicable range.

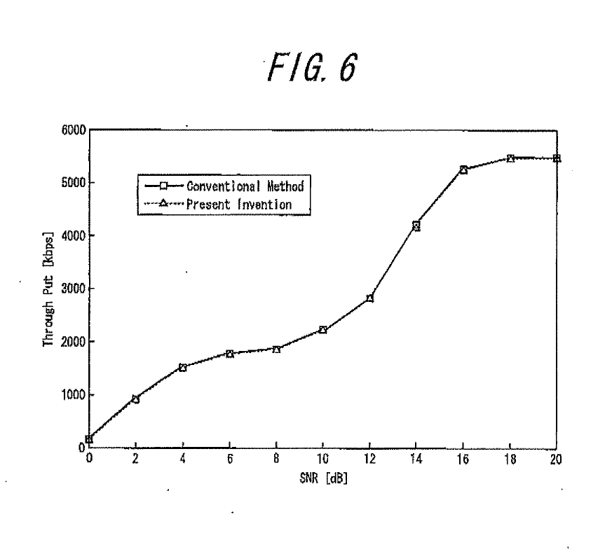

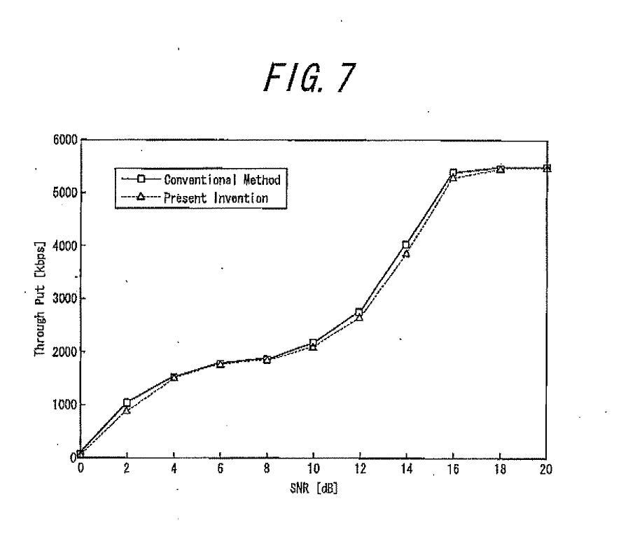

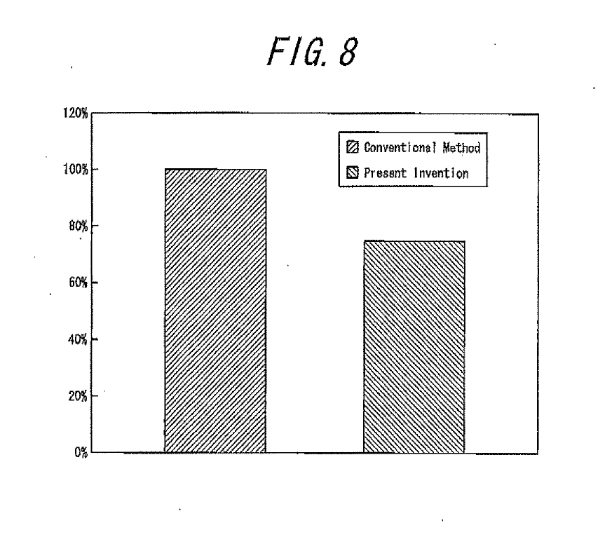

FIG. 6 and FIG. 7 are diagrams illustrating throughput characteristics at a MIMO communication, when employing the transmission weight selection method according to the embodiment of the present invention and the conventional transmission weight selection method, FIG. 6 shows characteristics when the channel selectivity of the channel is relatively mild (Pedestrian-B), whereas FIG. 7 shows the characteristics when the channel selectivity is severe (Enhanced Typical Urban). In addition, FIG. 8 is a diagram illustrating the calculation amounts by the transmission weight selection method according to the embodiment of the present invention and by the conventional transmission weight selection method. As can be seen in FIG. 6 to FIG. 8, the transmission weight selection method according to the embodiment of the present invention achieves the throughput equivalent to that of the conventional method with a small calculation amount (about 25% less).

Although the present invention is described based on figures and the embodiment, it is to be understood that those skilled in the art may easily vary or modify in a multiple manner based on disclosure of the present invention. Accordingly, such variation and modification are included in a scope of the present invention.

Although the power is used as the determination standard for the channel variation in the above embodiment, it is possible to use another standard such as, for example, a phase or amplitude, For example, if the phase is used as the standard, it is possible that the reception unit 10 detects the phase of the CSI and the channel variation determination unit 50 determines that there is a variation if a rotational direction of the phase is reversed between adjacent channels. Moreover, in focusing on a rotational amount of the phase, it is possible that the channel variation determination unit 50 determines that there is a variation if there is a subcarrier with a rotational amount of the phase move than a predetermined threshold. If the amplitude is used as the standard, it is possible that the reception unit 10 detects the amplitude and the channel variation determination unit 50 determines that there is a variation if there is the subcarrier with the amplitude lower than a threshold. In addition, although the above embodiment discusses simply about the CSI between the antennas, it is also possible, for example, to use the power, as a system multiplying the CSI by the weight of the transmission and the reception, as the standard.

In addition, the present invention is not limited to switchover, in all transmission weight applicable scope uniformly, between the individual calculation of the SINR of the transmission weight candidates and each CSI and the calculation of the SINR of the transmission weight candidates and only the representative CSI (average value of the CSI in the transmission weight applicable range), depending on whether there is a variation in the CSI. It will be appreciated that the present invention also includes a mode which switches processing, in each transmission weight applicable range, between, for example, the individual calculation of the SINR of the transmission weight candidates and each CSI for the transmission weight applicable range (for example, subband) with a large variation in the CSI and the calculation of the &Nit of only the representative CSI (average value of the CSIs in the transmission weight applicable range) and the transmission weight candidates for the transmission weight applicable range with no variation in the CSI.

Also, the present invention is not limited to a wireless communication scheme such as E-UTRA (LTE) and UMB but is applicable to any wireless communication scheme corresponding to the feedback MIMO.

### REFERENCE SIGNS LIST

1 communication terminal
2 base station
10 reception unit
20 CSI calculation unit
30 transmission weight selection unit
40 transmission unit
50 channel variation determination unit

1. A wireless communication apparatus having a plurality of antennas comprising:
a reception unit for receiving signals of channels included in a predetermined frequency band from another wireless communication apparatus and for obtaining channel state information of the channels;
a determination unit for determining a variation in the channel state information;
a channel state information calculation unit for calculating an average value of all of the channel state information included in the predetermined frequency band as representative channel state information of the predetermined frequency band overall if there is no variation in the channel state information;
a transmission weight selection unit for selecting a transmission weight based on the representative channel state information calculated; and
a transmission unit for transmitting identification information of the transmission weight to the another wireless communication apparatus.

2. The wireless communication apparatus according to claim 1, wherein the determination unit determines that there is no variation in the channel state if all of the channel state information is equal to or over a threshold based on the average value of all of the channel state information.

3. The wireless communication apparatus according to claim 1, wherein the transmission weight selection unit stores a corresponding relation between the channel state information and the transmission weight and selects the transmission weight stored corresponding to the representative channel state information.

4. A wireless communication method of a wireless communication apparatus having a plurality of antennas comprising the steps of:
receiving signals of channels included in a predetermined frequency band from another wireless communication apparatus and obtaining channel state information of the channels;
determining whether there is a variation in the channel state information;
calculating an average value of all of the channel state information included in the predetermined frequency band as representative channel state information of the predetermined frequency band overall if there is no variation in the channel state information;
selecting a transmission weight based on the representative channel state information calculated; and
transmitting identification information of the transmission weight to the another wireless communication apparatus.

5. The wireless communication method according to claim 4, wherein it is determined at the step of determination that there is no variation in the channel state if all of the channel state information is equal to or over a threshold based on the average value of the channel state information.

6. The wireless communication method according to claim 4, wherein at the step of selecting the transmission weight, the transmission weight corresponding to the representative channel state information is selected based on a corresponding relation between the channel state information and the transmission weight, stored in advance.

7. The wireless communication apparatus according to claim 2, wherein the transmission weight selection unit stores a corresponding relation between the channel state information and the transmission weight and selects the transmission weight stored corresponding to the representative channel state information.

8. The wireless communication method according to claim 5, wherein at the step of selecting the transmission weight, the transmission weight corresponding to the representative channel state information is selected based on a corresponding relation between the channel state information and the transmission weight, stored in advance.
